(19) United States
(12) Patent Application Publication
(10) Pub. No.: US 2018/0079619 A1
(43) Pub. Date: Mar. 22, 2018

(54) DIGITAL MEDIA LED MONITOR AND SCREEN BUILT INTO EXTERNAL OR INTERNAL ELEVATOR DOOR

(71) Applicants: Protouch Ltd., Petach Tikva (IL); Electra Ltd., Ramat Gan (IL)

(72) Inventors: Shlomi BEN ABAT, Petach Tikva (IL); Amit Mor, Ramat Gan (IL)

(21) Appl. No.: 15/708,240

(22) Filed: Sep. 19, 2017

Related U.S. Application Data
(60) Provisional application No. 62/396,244, filed on Sep. 19, 2016.

(51) Int. Cl. B66B 3/00; B66B 13/30

(52) U.S. Cl. CPC B66B 3/008; B66B 13/303; B66B 13/301

(57) ABSTRACT

A digital media system for an elevator in which media content is viewable from outside the elevator. A sending smart card within an elevator shaft and at least one stationary external elevator door comprising: (a) a rigid door frame body; (b) an LED monitor including (i) a receiving smart card configured for receiving the video content and (ii) an LED screen configured to receive a continuous flow of media content, the media content visible to viewers outside the elevator at least when the external elevator doors are closed. The LED monitor either occupies an external surface of the door frame body or the door frame body includes a transparent external wall section. System also includes a flexible tube that houses at least one power cable. Opening and closing of the doors does not disrupt the continuous flow of media content to the LED screen.

### FIELD AND BACKGROUND OF THE INVENTION

The present invention relates to elevators, and more particularly, to apparatus incorporated into elevator doors to provide digital media.

Media content, including digital media, in elevators are presently limited to displays in the elevator car itself for the viewing pleasure of the passengers in the elevator.

### SUMMARY OF THE INVENTION

One aspect of the invention is a digital media system for an elevator in which media content is viewable from outside the elevator, comprising a smart card positioned within an elevator shaft and configured to send video content; at least one stationary external elevator door configured to remain attached to a building when an elevator car moves up or down the elevator shaft and configured to operate in tandem with an internal elevator door, the at least one stationary external elevator door comprising: (a) a rigid door frame body including at least one door that opens and closes; (b) an LED monitor including (i) a receiving smart card, the receiving smart card configured for receiving the video content and (ii) an LED screen configured to receive a continuous flow of media content, the media content visible to viewers outside the elevator at least when the external elevator doors are closed, wherein either the LED monitor occupies an external surface of the door frame body or the door frame body includes a transparent external wall section in at least an area corresponding substantially in height and width to the LCD screen, wherein the system is configured to work in conjunction with at least one power cable situated on an internal side of the external elevator door such that opening and closing of the external and internal elevator doors does not disrupt the continuous flow of the media content to the LED screen.

A further aspect of the invention is a digital media system for an elevator in which media content is viewable from outside the elevator, comprising a smart card positioned within an elevator shaft and configured to send video content; an internal elevator door forming part of, and moving with, the elevator car, the internal elevator door configured for working with an external elevator door that remains attached to the building, the internal elevator door comprising: (a) a rigid door frame body including at least one door that opens and closes; (b) an LED monitor including (i) a receiving smart card, the receiving smart card configured for receiving the video content and (ii) an LED screen configured to receive a continuous flow of media content and to provide the media content visible to prospective passengers of an external waiting area at least when the internal and external elevator doors are closed, wherein either the LED monitor occupies an external surface of the door frame body or the door frame body includes a transparent external wall section in at least an area corresponding substantially in height and width to the LCD screen, wherein the system is configured to work in conjunction with at least one power cable situated on an internal or external side of the internal elevator door wherein an end of the flexible tube is accessible to the elevator shaft such that opening and closing of the external and internal elevator doors does not disrupt a continuous flow of media content to the LED screen, wherein the external elevator door includes a transparent external wall section in at least the area corresponding substantially in height and width to the LCD screen.

A still further aspect of the invention is a digital media apparatus for an elevator that provides digital media viewable from outside the elevator, comprising a sending smart card positioned within an elevator shaft and configured to send video content; an LCD monitor is configured to be embedded in either (i) at least one stationary external elevator door configured to remain attached to a building when an elevator car moves up or down the elevator shaft or (ii) at least one internal elevator door forming part of, and moving with, the elevator car, the LED monitor including (i) a receiving smart card, the receiving smart card configured for receiving the video content and (ii) an LED screen configured to receive a continuous flow of media content, the media content visible to viewers outside the elevator at least when the external elevator doors are closed, the LED monitor is either configured to occupy an external surface of a door frame of the external elevator door or of the internal elevator door or the LED monitor is configured to be embedded into the external elevator door or the internal elevator door.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a photograph of an LED display shown from the front built in to one side of an external elevator door (or of an internal elevator door), in accordance with one embodiment of the invention;

FIG. 2 is a photograph of the rear of an LED display built into one side of an external elevator door (or of an internal elevator door), in accordance with one embodiment of the invention;

FIG. 3 is a front view of external elevator doors incorporating LED displays, in accordance with one embodiment of the invention; and

FIG. 4 is a photograph showing a view, from inside the elevator shaft and with the external elevator door closed, of a flexible tube holding cables, passing through a door frame of an external elevator door to avoid interfering with opening and closing of elevator doors, in accordance with one embodiment of the invention;

FIG. 5 is a photograph showing a view, from inside the elevator shaft as in FIG. 4 and with the external elevator door open, of a flexible tube holding cables, in accordance with one embodiment of the invention;

FIG. 6 is a schematic showing a system where the LED monitor is built into an external elevator door, in accordance with one embodiment of the invention;

FIG. 7 is a schematic illustration of an apparatus, in accordance with one embodiment of the invention; and

FIG. 8 is a flow chart of a production method, in accordance with one embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a digital media apparatus for external or internal elevator doors. Digital media content, on, for example, an LED screen of an LED monitor, is shown to passengers waiting for an elevator. The LED screen is built into the external elevator door. In other embodiments, the LED screen is built into the internal elevator door. In some embodiments, digital media content flows continuously to the LED screen whether the elevators doors (external and internal) are closed or open. At least when the elevator doors (both the internal and external door which move in tandem) are closed, people outside the elevator, for example prospective passengers in a waiting area or the general public, are able to view the media content on the LED screen. In some embodiments, for example if the building walls adjacent the elevator doors are transparent, people outside the elevator are able to view the media content on the LED screen even when the elevator doors are open.

In some embodiments, the system or apparatus described herein creates an LED display that is incorporated into elevator doors. This provides in some embodiments, smooth operation of the broadcast of digital media of any kind into the LED screen on-site or remotely, thus making the elevator doors (external elevator doors or internal elevator doors) a digital media broadcasting hub. High quality materials used in the LCD monitor and associated equipment ensures a light-weight seamless digital unit that is incorporated into the frame of the elevator door, with concealed, flexible wiring. This provides a smooth operating door that can open and close with no interference 24/7.

The principles and operation of a digital media led monitor and screen built into an external or internal elevator door may be better understood with reference to the drawings and the accompanying description.

As shown in FIG. 1 through FIG. 7, the invention in one embodiment is a digital media system 10 for an elevator door configured to be viewable from outside an elevator. System 10 may comprise a compact receptacle for integrated circuitry, for example a smart card 20, positioned within an elevator shaft 30 and configured to send video content. The “smart card” used herein refers to a portable and compact, usually but not necessarily card-shaped, receptacle or substrate that has embedded within it integrated circuits, such as a microchip, and that includes communications software for sending and/or receiving video digital media content. The smart cards 20, 62 handle any digital media content. In one non-limiting example, the media content is sent as a continuous flow. In one further non-limiting example, the flow of digital media content is streaming video.

A digital media system 10 for an elevator in which media content is viewable from outside the elevator, includes, in one embodiment, at least one stationary external elevator door 40 configured to remain attached to a building when an elevator car moves up or down the elevator shaft. The elevator in general, the elevator car specifically and the elevator shaft 30 specifically are not part of the system 10, as described in this embodiment.

System 10, in this first embodiment, does not include the internal elevator door 50. It is noted that the internal elevator door 50, once installed, forms part of the elevator car and moves with the elevator. In this embodiment, the elevator car is not part of system 10 in accordance with this embodiment. It is noted that the external elevator door 40 and the internal elevator door 50 are configured to open and close in tandem at at least certain floors, and typically at all floors. In some other embodiments of the invention, a system or apparatus of the invention may include system 10 (or apparatus 11) plus the elevator car itself (and even other equipment including any hardware/software of the elevator itself.

As shown in FIGS. 1-6, system 10 may comprise at least one stationary external elevator door 40. External elevator door 40 comprises (a) a rigid door frame body 42 including at least one door 40a that opens and closes. In a typical case, external elevator door 40 includes a left door 40a and a right door 40b, although in other cases at least one door 40a may comprises a single door 40a that is configured to open by moving to a position mostly unseen by passengers for example behind or within a wall of the building structure adjacent the elevator. External elevator door 40 is configured to work with the internal elevator door 50 (opening and closing together), although internal door 50 is not part of system 10 in this embodiment.

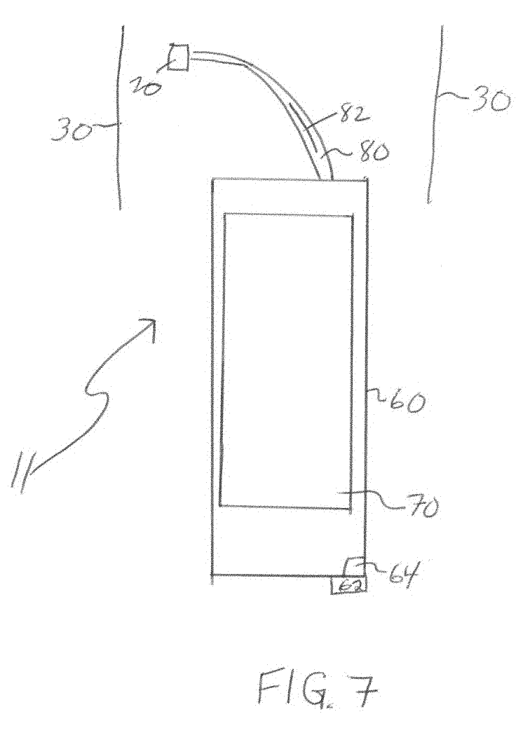

In this embodiment of system 10, external elevator door 40 also comprises an LED monitor 60 built into it. The LED monitor 60 includes a frame that in some embodiments is made of at least one of aluminum, stainless steel, iron and plastic. LED monitor 60 includes in some embodiments at least a controller 62 that is a receiving smart card 62, the receiving smart card 62 configured for receiving the video content. LED monitor 60 also include an LED screen 70 configured to receive a continuous flow of media content. As shown in FIG. 6, receiving smart card 62 is typically within an upper section 61 or a lower section of LED monitor 60. However, in other embodiments of system 10 and of apparatus 11, the controller/receiving smart card 62 is embedded within the LED screen 70 itself, although this version is not specifically shown in the drawings. Accordingly, when throughout this application the monitor 60 is referred to as having both a receiving smart card 62 and an LED screen 70, this includes a permutation in which the receiving smart card 62 is embedded within the LED screen 70.

The LED screen 70 is part of the LED monitor 60 that may be installed into the external elevator door 40 (for example within a frame 41 (FIG. 1) of the door 40). LED screen 70 may include a non-transparent surface which is configured to display digital information such as images or video clips. The LED screen 70 is in some embodiments specifically customized to be a thin display unit. For example, in one embodiment, an average thickness of the LED monitor is between 5 mm and 30 mm. In another embodiment the average thickness of the LED monitor (including the screen 70 and including the back of the LED monitor frame) is between 10 mm and 22 mm. In a certain embodiment, LED monitor is only 20 mm thick, to guarantee the ability of the external elevator doors (or the internal elevator doors if the LED monitor is installed in the internal elevator door 50) to have smooth and quality operation. The LED screen 70 is in some embodiments encased within a custom made frame of the LED monitor 60 that provides ease of installation and concealment of all wiring associated with the LED screen 70. All wiring is then fed through door frame in a flexible tube 80 or pipeline to allow a smooth operation and no interference to elevator doors being opened and closed.

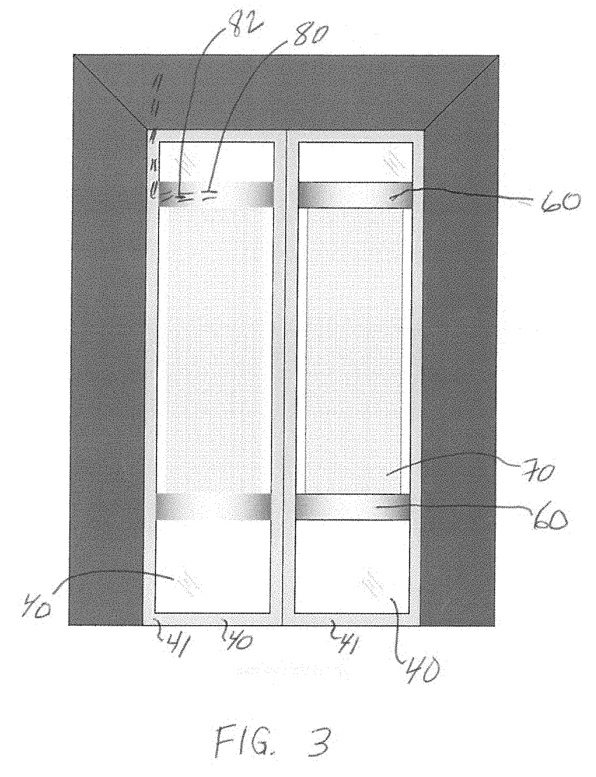

In accordance with system 10, as seen from FIG. 3, the media content on screen 70 is visible to viewers outside the elevator at least when the external elevator doors are closed. In some embodiments, the media content on the LED screen is visible to viewers outside the elevators also when the internal and external elevator doors are open. In one example, this is the case (the media content is visible to viewers outside the elevators also when the internal and external elevator doors are open) if the external elevator door 40 opens by moving to within the adjacent building structure or wall and this building structure or wall is transparent. It is noted that often, for example in malls, elevators are not built into the inside of a building but rather attached to separate structure that is attached to the regular building structure.

In some embodiments, the LED monitor 60 occupies an external surface of the door 40 frame body. In other embodiments, the LED monitor 60 is embedded within the door 40 but is visible because the door 40 frame body includes a transparent external wall section that is transparent in at least an area corresponding substantially in height and width to the LCD screen 70.

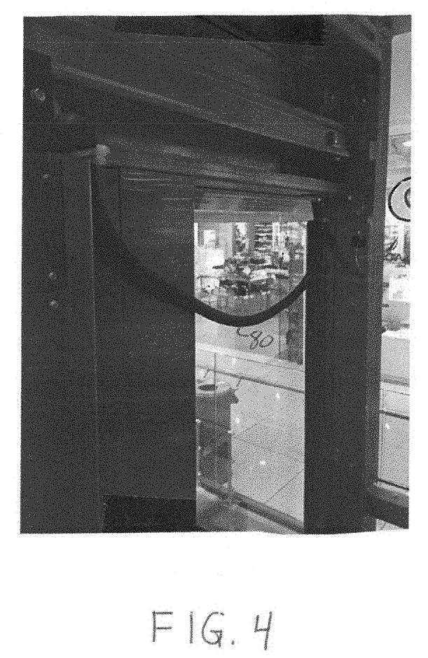

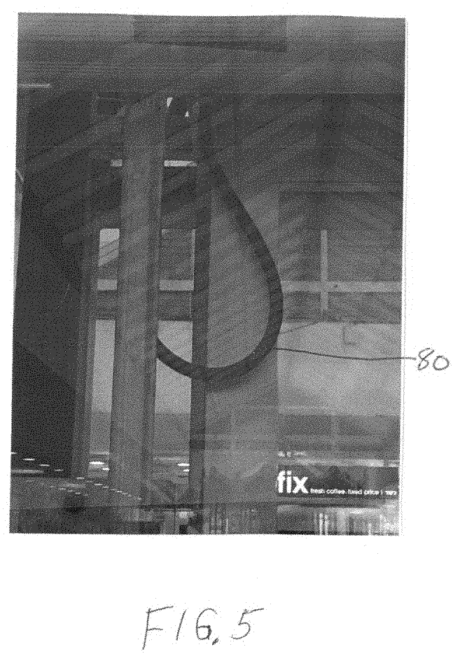

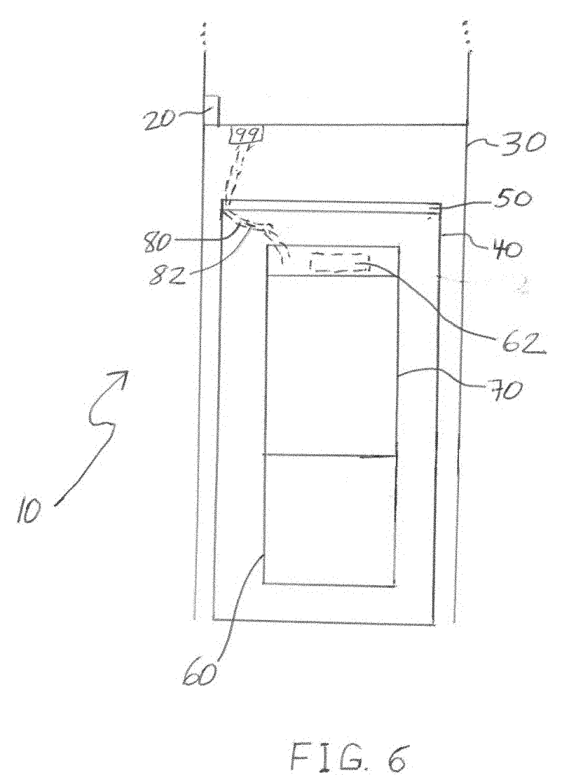

System 10, in some embodiments, is configured to work with a connector 80 such as a cable 82. In this version, system 10 does not include the connector 80 or cable 82. On the other hand, system 10 may in some embodiments also comprises a connector 80. For example, as seen in FIG. 4 and FIG. 5 tube 80 is in some embodiments a flexible tube 80 that houses at least one power cable 82 (typically extending throughout the length of the tube 80) situated on an internal side of the external elevator door wherein an end of the flexible tube 80 is accessible to the elevator shaft 30 such that opening and closing of the external and internal elevator doors 40, 50 does not disrupt the continuous flow of the media content to the LED screen 70.

In one particular non-limiting example, a 20 mm thick LED screen 70 is encased in an aluminum frame of the LED monitor 60 and installed inside transparent external (or internal 50) elevator door 40, and is adapted to operate under conditions of full operation of the elevator and the elevator doors 40, 50. It is noted that the elevator door can be opaque in portions of the door other than where the screen 70 is.

In general, the LED monitor 60 and LED screen 70 can be installed either in an existing elevator door 40, 50 that is transparent or else a pre-fabricated custom-made transparent elevator door can be constructed for commercial or private use. The receiving smart card 62 and the sending smart card 20 are compatible with one or a combination of a USB port, internet connection, Ethernet connection, WIFI and wired connection. In one embodiment, the smart cards 20, 62 operate on an external control system such as USB or remotely via internet access or using a WIFI connection.

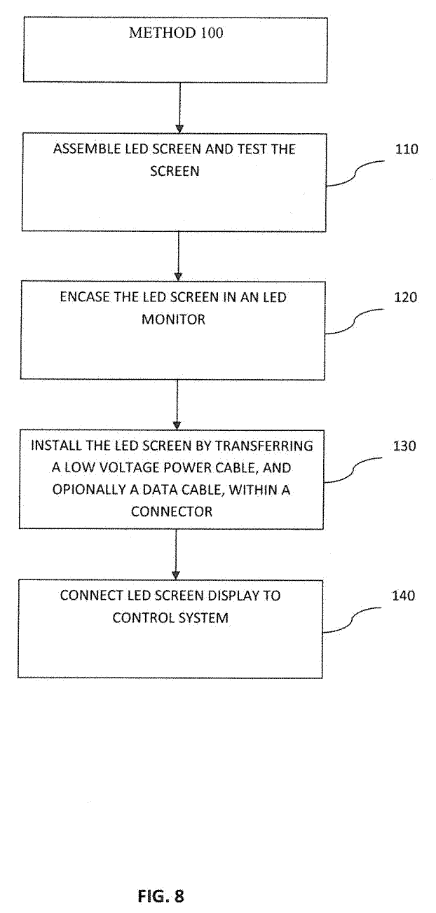

In one particular non-limiting example of the LED monitor 60, one creates a new module thickness of 15 mm by removing the plastic encasing of a standard LED monitor, creating allocated cuts for flat wiring passage in back of the LED monitor and then transferring low voltage power and data wiring in flexible tube. The wires may be extended through the doorpost of the elevator doors (external or internal elevator doors) to an external power supply that is safely installed within the elevator shaft. In this way, wiring for the LED monitor is not visible from outside the elevator or to elevator car passengers. In addition, in some embodiments, the controller 62 of the LED monitor 60 is removed and mounted outside the LED monitor so as to reduce the thickness thereof, but controller 62 cannot be too far away from the LED monitor As shown in FIG. 8, an embodiment of the invention is a production method 100 for making system 10 (or apparatus 11). Method 100 in one embodiment includes a step 110 of assembling the LED screen 70. This may include determining and setting the LED distance view, the pixel pitch size, the LED screen size and the resolution. Another step may include making integral adjustments to the screen depth of for example 20 mm, by removing the LED screen from its original casing and creating an installation technique to a custom installation frame, using screws. In this manner, installation does not exceed elevator door frame depth limitation, eliminating any issues of interference to the smooth operation of the elevator. The wires may be welded directly to the controller 62 of the LED screen 70 while the controller 62 may be disposed in the aluminum (or other material) body/frame of the LED monitor 60 such that the wires are shortened and interference is eliminated. In some embodiments, tape-worm wiring is utilized between multiple modules to assure minimal depth. Another step involves installation of the LED card to the LED monitor 60 to assure minimal depth. The LED screen 70 is tested in some version of the production process.

A further step 120 in the production process in some embodiments is encasing the LED screen 70 in the LED monitor 60 frame. After testing, LED screen 70 is encased into a custom-made LED monitor 60 that is made of aluminum, stainless steel, iron or plastic or a combination thereof. The material thickness of the LED monitor (including the LED screen 70 and its backing) is typically only 20 mm. This allows the LED screen to be between 5 and 30, or in other embodiment between 10 and 22 mm thick. LCD screen 70 is then mounted to an inner part of exterior elevator door frame. The aluminum or other material guarantees highest LED installation precision and a clean look from the elevator chamber. All wiring and the back of LED screen 70 is neatly concealed from sight. If aluminum is chosen, this ensures light weight.

In some embodiments of the production process, a step 130 is installing the LED screen by transferring a low voltage power cable 82 and optionally a communications cable (if the system/apparatus is not wireless) within a connector such as a flexible tube 80. The power cable 82 and in some embodiments the communication cable is transferred within flexible tube 80 as seen in FIG. 4 and FIG. 5. For example, as shown in FIGS. 4-5, flexible tube 80 may be passed through elevator door frame, and out to elevator shaft to a designated area, where there is no interference with the elevator door being opened or closed at all times of the day (24/7).

In some embodiments, another step 140 of the production process 100 is connecting LED screen 70 to the control system. The control system refers to the smart card and a power supply. Smart card 20, 62 may be a video card with USB, internet and WIFI capabilities. Smart card 20 is configured to send information either locally through a wired connection or remotely through a wireless connection. The power supply 99 (FIG. 6) enables all power usage to and from LED monitor 60 and LED screen 70 and its wiring.

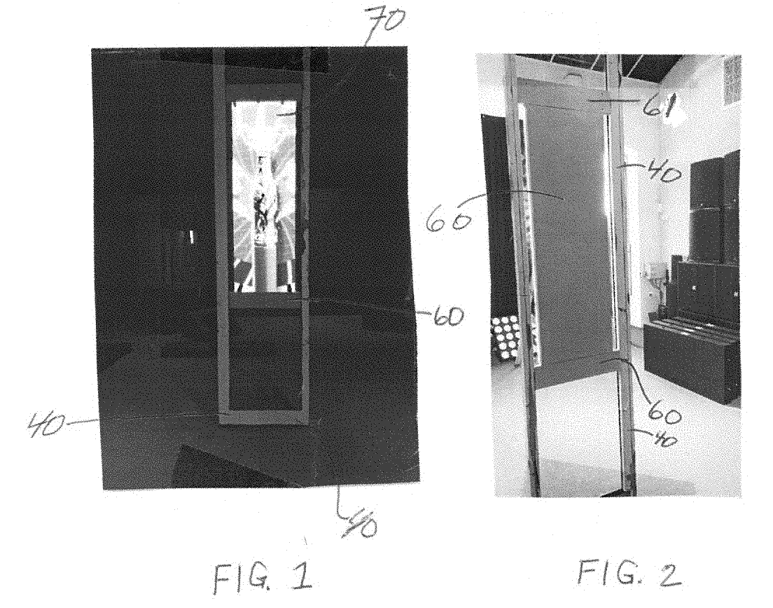

Another embodiment of the invention is a digital media system 10 for an elevator in which media content is viewable from outside the elevator, and in which the LED monitor 60 is built into the internal elevator door 50 (FIG. 6) rather than into the external elevator door 40, as in the previous embodiment. In this “internal elevator door” embodiment, system 10 still comprises a smart card 20 positioned within an elevator shaft 30 and configured to send video content. Although FIGS. 1-2 are shown as utilizing an external elevator 40, it should be understood that FIGS. 1-2 apply equally well to this embodiment in which the LED monitor 60 is built into an internal elevator door 50.

System 10, in this embodiment, does not include the at least one stationary external elevator door configured to remain attached to a building when an elevator car moves up or down the elevator shaft but rather includes the internal elevator door 50 forming part of, and moving with, the elevator car. It is noted that the external elevator door and the internal elevator door 50 are configured to work together, i.e. to open and close in tandem at at least certain floors.

In this embodiment, the internal elevator door 50 (shown in FIG. 6 sticking out behind the external elevator door 40) may comprise (a) a rigid door frame body including at least one door that opens and closes; (b) an LED monitor including (i) a controller that is a receiving smart card 62, the receiving smart card configured for receiving the video content and (ii) an LED screen configured to receive a continuous flow of media content and to provide the media content visible to prospective passengers of an external waiting area at least when the internal and external elevator doors are closed.

In this embodiment, either the LED monitor 60 occupies an external surface of the door frame body or the door frame body includes a transparent external wall section in at least an area corresponding substantially in height and width to the LCD screen 70.

In this internal elevator door embodiment, system 10 is configured to work with a connector 80 that houses a cable 82. In this version, the connector 80 and cable 82 are not actually part of system 10. On the other hand, system 10 may also comprise, in some versions of this internal elevator door embodiment, a connector 80 such as a flexible tube 80 that houses at least one power cable situated on an internal or external side of the internal elevator door wherein an end of the flexible tube accessible to the elevator shaft such that opening and closing of the external and internal elevator doors does not disrupt a continuous flow of media content to the LED screen 70.

In this embodiment, the external elevator door 40 may include a transparent external wall section in at least the area corresponding substantially in height and width to the LCD screen.

The other details of the system 10 remain the same. For example, in some versions of the system 10 the media content is visible to viewers outside the elevators also when the internal and external elevators doors are open. In some versions, an average thickness of the LED monitor is between 5 mm and 30 mm. In other versions of the system the average thickness of the LED monitor is between 10 mm and 22 mm. The materials of the LED monitor are not different from the embodiment in which the LED monitor is in the external elevator door 40, the wiring and the receiving card and sending card for this internal elevator door 50 embodiment are not different.

In another embodiment that comprises the LED monitor and associated equipment without the elevator door or doors, the invention shown in FIG. 7 is a digital media apparatus 11 for an elevator that provides digital media viewable from outside the elevator. Apparatus 11 comprises a smart card 20 positioned within an elevator shaft 30 and configured to send video content.

Apparatus 11 includes an LCD monitor 60 configured to be embedded in either (i) at least one stationary external elevator door configured to remain attached to a building when an elevator car moves up or down the elevator shaft or (ii) at least one internal elevator door forming part of, and moving with, the elevator car.

LED monitor 60 in some embodiments includes (i) a controller that is a receiving smart card 62, the receiving smart card configured for receiving the video content and (ii) an LED screen 70 that is configured to receive a continuous flow of media content. The media content in some embodiments is visible to viewers outside the elevator at least when the external elevator doors are closed.

LED monitor 60 is either configured to occupy an external surface of a door frame of the external elevator door 40 or the internal elevator door 50 or configured to be embedded into the external elevator door 40 or the internal elevator door 50.

In some embodiments, apparatus 11 is configured to work with a connector 80 for example a connector 80 that houses a cable 82. In this version of apparatus 11, the connector 80 and cable 82 are not actually part of apparatus 11. On the other hand, in some versions of apparatus 11, apparatus 11 may also comprise a connector 80, such as a flexible tube 80, that houses at least one power cable 82 that may be situated on an internal side of the external elevator door 40 or on an internal side or external side of the internal elevator door 50. An end of flexible tube 80 is accessible to the elevator shaft 30 such that opening and closing of the external and internal elevator doors does not disrupt the continuous flow of the media content to the LED screen. Although FIG. 7 shows the tube 80 having within it the cable 82 reaching the sending smart card 20, in other embodiments, the sending smart card 20 is wireless and therefore the cable 82 reaches a power supply (not shown in FIG. 7) within shaft 30.

In some embodiments, the media content is visible to viewers outside the elevators also when the internal and external elevators doors are open.

It is noted that although FIG. 4 and FIG. 5 show the flexible tube 80 sagging, in a typical embodiment of the invention, flexible tube 80 would be more taut and would be better concealed from view of people outside the elevator.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A digital media system for an elevator in which media content is viewable from outside the elevator, comprising:
a smart card positioned within an elevator shaft and configured to send video content;
at least one stationary external elevator door configured to remain attached to a building when an elevator car moves up or down the elevator shaft and configured to operate in tandem with an internal elevator door,
the at least one stationary external elevator door comprising:
(a) a rigid door frame body including at least one door that opens and closes;
(b) an LED monitor including (i) a receiving smart card, the receiving smart card configured for receiving the video content and (ii) an LED screen configured to receive a continuous flow of media content, the media content visible to viewers outside the elevator at least when the external elevator doors are closed,
wherein either the LED monitor occupies an external surface of the door frame body or the door frame body includes a transparent external wall section in at least an area corresponding substantially in height and width to the LCD screen,
wherein the system is configured to work in conjunction with at least one power cable situated on an internal side of the external elevator door such that opening and closing of the external and internal elevator doors does not disrupt the continuous flow of the media content to the LED screen.

2. The system of claim 1, wherein the media content is visible to viewers outside the elevators also when the internal and external elevator doors are open.

3. The system of claim 1, wherein an average thickness of the LED monitor is between 5 mm and 30 mm.

4. The system of claim 1, wherein an average thickness of the LED monitor is between 10 mm and 22 mm.

5. The system of claim 1, wherein the LED monitor frame is made of at least one of aluminum, stainless steel, iron and plastic.

6. The system of claim 1, wherein the receiving card and sending card are compatible with a USB port, internet connection, Ethernet connection, WIFI and wired connection.

7. The system of claim 1, wherein wiring for the LED monitor is not visible from outside the elevator or to elevator car passengers.

8. The system of claim 1, further comprising the internal elevator door.

9. The system of claim 1, further comprising a flexible tube that houses the at least one power cable situated on an internal side of the external elevator door wherein an end of the flexible tube is accessible to the elevator shaft such that opening and closing of the external and internal elevator doors does not disrupt the continuous flow of the media content to the LED screen.

10. A digital media system for an elevator in which media content is viewable from outside the elevator, comprising:
a smart card positioned within an elevator shaft and configured to send video content;
an internal elevator door forming part of, and moving with, the elevator car, the internal elevator door configured for working with an external elevator door that remains attached to the building,
the internal elevator door comprising:
(a) a rigid door frame body including at least one door that opens and closes;
(b) an LED monitor including (i) a receiving smart card, the receiving smart card configured for receiving the video content and (ii) an LED screen configured to receive a continuous flow of media content and to provide the media content visible to prospective passengers of an external waiting area at least when the internal and external elevator doors are closed,
wherein either the LED monitor occupies an external surface of the door frame body or the door frame body includes a transparent external wall section in at least an area corresponding substantially in height and width to the LCD screen,
wherein the system is configured to work in conjunction with at least one power cable situated on an internal or external side of the internal elevator door wherein an end of the flexible tube is accessible to the elevator shaft such that opening and closing of the external and internal elevator doors does not disrupt a continuous flow of media content to the LED screen,
wherein the external elevator door includes a transparent external wall section in at least the area corresponding substantially in height and width to the LCD screen.

11. The system of claim 10, wherein the media content is visible to viewers outside the elevators also when the internal and external elevators doors are open.

12. The system of claim 10, wherein an average thickness of the LED monitor is between 5 mm and 30 mm.

13. The system of claim 10, wherein an average thickness of the LED monitor is between 10 mm and 22 mm.

14. The system of claim 10, wherein the LED monitor frame is made of aluminum.

15. The system of claim 10, wherein the receiving card and sending card are compatible with a USB port, internet connection, Ethernet connection, WIFI and a wired connection.

16. The system of claim 10, wherein wiring for the LED monitor is not visible from outside the elevator or to elevator car passengers.

17. The system of claim 10, further comprising the external elevator door.

18. The system of claim 10, further comprising a flexible tube that houses the at least one power cable situated on an internal or external side of the internal elevator door wherein an end of the flexible tube is accessible to the elevator shaft such that opening and closing of the external and internal elevator doors does not disrupt a continuous flow of media content to the LED screen.

19. A digital media apparatus for an elevator that provides digital media viewable from outside the elevator, comprising:
a sending smart card positioned within an elevator shaft and configured to send video content;
an LCD monitor is configured to be embedded in either (i) at least one stationary external elevator door configured to remain attached to a building when an elevator car moves up or down the elevator shaft or (ii) at least one internal elevator door forming part of, and moving with, the elevator car,
the LED monitor including (i) a receiving smart card, the receiving smart card configured for receiving the video content and (ii) an LED screen configured to receive a continuous flow of media content, the media content visible to viewers outside the elevator at least when the external elevator doors are closed,
the LED monitor is either configured to occupy an external surface of a door frame of the external elevator door or of the internal elevator door or the LED monitor is configured to be embedded into the external elevator door or the internal elevator door.

20. The apparatus of claim 19, further comprising a flexible tube that houses at least one power cable situated on an internal side of the external elevator door or on an internal or external side of the internal elevator door, wherein an end of the flexible tube is accessible to the elevator shaft such that opening and closing of the external and internal elevator doors does not disrupt the continuous flow of the media content to the LED screen.

21. The apparatus of claim 20, wherein the media content is visible to viewers outside the elevators also when the internal and external elevators doors are open.
